(19) United States
(12) Patent Application Publication
(10) Pub. No.: US 2024/0394846 A1
(43) Pub. Date: Nov. 28, 2024

(54) TRAINING METHOD AND APPARATUS OF IMAGE RECONSTRUCTION MODEL, AND MEDIUM

(71) Applicant: TENCENT TECHNOLOGY (SHENZHEN) COMPANY LIMITED, Shenzhen (CN)

(72) Inventors: Yawen HUANG, Shenzhen (CN); Yefeng ZHENG, Shenzhen (CN); LE ZHANG, Shenzhen (CN)

(21) Appl. No.: 18/787,991

(22) Filed: Jul. 29, 2024

Related U.S. Application Data
(63) Continuation of application No. PCT/CN2023/082436, filed on Mar. 20, 2023.

(30) Foreign Application Priority Data
May 10, 2022 (CN) 202210508810.2

(51) Int. Cl. G06T 5/60; G06T 5/50; G06V 10/40

(52) U.S. Cl. CPC G06T 5/60; G06T 5/50; G06T 2207/20081; G06T 2207/20221; G06T 2207/30004; G06V 10/40

(57) ABSTRACT

A training method includes: obtaining a first sample image and at least two types of second sample images; respectively adding at least two damage feature corresponding to the second sample images to the first sample image, to generate at least two types of single degradation images; fusing the single degradation images, to obtain a multiple degradation image corresponding to the first sample image; performing image reconstruction processing on the multiple degradation image, to generate a predicted reconstruction image corresponding to the multiple degradation image; calculating a loss function value based on the second sample images, the single degradation images, the first sample image, and the predicted reconstruction image; and updating a model parameter of the model based on the loss function value.

### CROSS-REFERENCES TO RELATED APPLICATIONS

This application is a continuation application of PCT Patent Application No. PCT/CN2023/082436, filed on Mar. 20, 2023, which claims priority to Chinese Patent Application No. 202210508810.2, filed on May 10, 2022 and entitled “TRAINING METHOD AND APPARATUS OF IMAGE RECONSTRUCTION MODEL, MEDIUM, AND PROGRAM PRODUCT”, both of which are incorporated herein by reference in entirety.

### TECHNICAL FIELD

Embodiments of the present disclosure relate to the field of image processing technologies, and specifically, to a training method and apparatus of an image reconstruction model, a device, a medium, and a program product.

### BACKGROUND

A high-quality three-dimensional image can present detailed information clearly. For example, in the medical field, a high-quality three-dimensional medical image is helpful for medical diagnosis and analysis. However, in a process of forming, recording, processing, and transmitting an image, image quality deteriorates due to imperfection of an imaging system, a recording device, a transmission medium, and a processing method.

In a related technology, a deep convolutional neural network can be used to learn mapping relationships between pairs of low-quality images and high-quality images, and a high-quality three-dimensional image can be generated by using the trained neural network based on a low-quality three-dimensional image.

However, when the low-quality three-dimensional image has a plurality of damaged parts, for example, a noise loss and an image loss, in the foregoing method, the damaged parts of the low-quality three-dimensional image are usually reconstructed in sequence. A result is that a reconstruction error in a first phase is propagated to a subsequent phase. As a result, an overall image reconstruction error is large.

### SUMMARY

The present disclosure provides a training method and apparatus of an image reconstruction model, a device, a medium, and a program product, to obtain an accurate image reconstruction result. The technical solutions are as follows:

According to one aspect of the present disclosure, a training method of an image reconstruction model is provided. The method includes: obtaining a first sample image and at least two types of second sample images, where a second sample image has a single damage type, and image quality of the first sample image is greater than image quality of the second sample image; respectively adding at least two damage features corresponding to the second sample images to the first sample image, to generate at least two types of single degradation images; and fusing the at least two types of the single degradation images, to obtain a multiple degradation image corresponding to the first sample image, where the multiple degradation image has at least two damage types; performing image reconstruction processing on the multiple degradation image, to generate a predicted reconstruction image corresponding to the multiple degradation image; calculating a loss function value based on the second sample images, the single degradation images, the first sample image, and the predicted reconstruction image; and updating a model parameter of the image reconstruction model based on the loss function value.

According to one aspect of the present disclosure, a training apparatus of an image reconstruction model is provided. The apparatus includes: an obtaining module, configured to obtain a first sample image and at least two types of second sample images, where the second sample image is an image having a single damage type, and image quality of the first sample image is greater than image quality of the second sample image; a degradation module, configured to respectively add at least two damage features corresponding to the second sample images to the first sample image, to generate at least two types of single degradation images; a fusion module, configured to fuse the at least two single degradation images, to obtain a multiple degradation image corresponding to the first sample image, where the multiple degradation image is an image having at least two damage types; a reconstruction module, configured to perform image reconstruction processing on the multiple degradation image, to generate a predicted reconstruction image corresponding to the multiple degradation image; a calculation module, configured to calculate a loss function value based on the second sample images, the single degradation images, the first sample image, and the predicted reconstruction image; and an updating module, configured to update a model parameter of the image reconstruction model based on the loss function value.

According to another aspect of the present disclosure, a computer device is provided. The computer device includes a processor and a memory. The memory stores at least one computer program, and the at least one computer program is loaded and executed by the processor to implement the training method of the image reconstruction model according to the foregoing aspect.

According to another aspect of the present disclosure, a non-transitory computer storage medium is provided. The computer-readable storage medium stores at least one computer program, and the at least one computer program is loaded and executed by a processor to implement the training method of the image reconstruction model according to the foregoing aspect.

A beneficial effect brought by the technical solutions provided in the present disclosure at least includes: the first sample image and at least two second sample images are obtained; the at least two damage features corresponding to the second sample images are respectively added to the first sample image, to generate the at least two single degradation images; the at least two single degradation images are fused, to obtain the multiple degradation image corresponding to the first sample image; then image reconstruction processing is performed on the multiple degradation image, to generate the predicted reconstruction image corresponding to the multiple degradation image; and a computer device calculates the loss function value based on the second sample images, the single degradation images, the first sample image, and the predicted reconstruction image; and updates the model parameter of the image reconstruction model based on the loss function value. According to the training method of the image reconstruction model provided in the present disclosure, image damage of a plurality of damage types is simultaneously performed on the first sample image, to obtain the multiple degradation image corresponding to the first sample image, and the multiple degradation image having the plurality of damage types is reconstructed. When the model obtained through training by using the foregoing method is used, a plurality of damage types of a low-quality image may be simultaneously reconstructed. This avoids an accumulated error caused by reconstructing the damage types of the low-quality image in sequence, and further improves image reconstruction precision of a trained image reconstruction model.

### BRIEF DESCRIPTION OF THE DRAWINGS

FIG. 1 is a schematic diagram of a training method of an image reconstruction model according to an exemplary embodiment of the present disclosure.

FIG. 2 is a schematic diagram of an architecture of a computer system according to an exemplary embodiment of the present disclosure.

FIG. 3 is a flowchart of a training method of an image reconstruction model according to an exemplary embodiment of the present disclosure.

FIG. 4 is a flowchart of a training method of an image reconstruction model according to an exemplary embodiment of the present disclosure.

FIG. 5 is a schematic diagram of a training method of an image reconstruction model according to an exemplary embodiment of the present disclosure.

FIG. 6 is a schematic diagram of a reconstruction effect of an image reconstruction model according to an exemplary embodiment of the present disclosure.

FIG. 7 is a schematic diagram of a reconstruction effect of an image reconstruction model according to an exemplary embodiment of the present disclosure.

FIG. 8 is a schematic diagram of a training method of an image reconstruction model according to an exemplary embodiment of the present disclosure.

FIG. 9 is a framework diagram of generation of an image reconstruction model and image reconstruction according to an exemplary embodiment of the present disclosure.

FIG. 10 is a flowchart of an image reconstruction method according to an exemplary embodiment of the present disclosure.

FIG. 11 is a schematic diagram of an image reconstruction method according to an exemplary embodiment of the present disclosure.

FIG. 12 is a block diagram of a training apparatus of an image reconstruction model according to an exemplary embodiment of the present disclosure.

FIG. 13 is a schematic diagram of a structure of a computer device according to an exemplary embodiment of the present disclosure.

### DETAILED DESCRIPTION

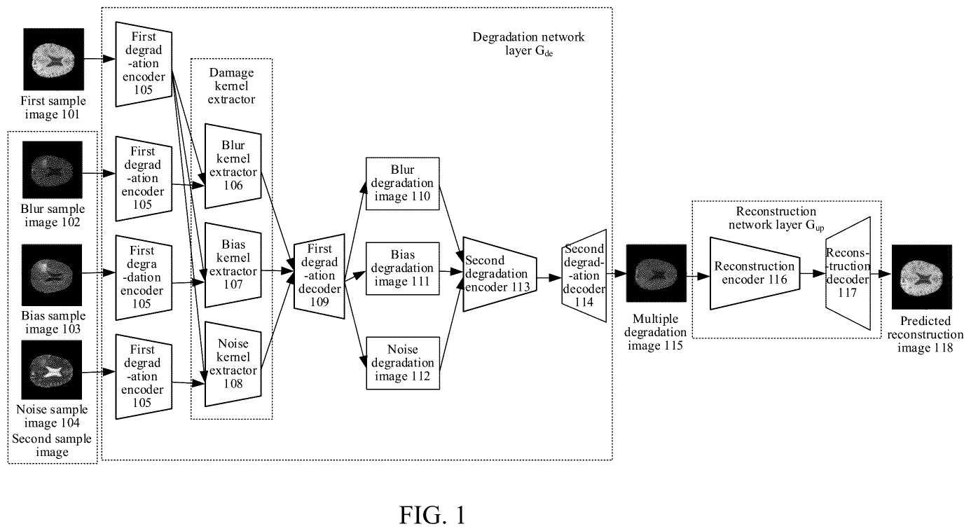

Embodiments of the present disclosure provide a technical solution of a training method of an image reconstruction model. As shown in FIG. 1, the method may be executed by a computer device, where the computer device may be a terminal or a server.

For example, the computer device obtains a first sample image 101 and at least two second sample images. The at least two second sample images include at least two of a blur sample image 102, a bias sample image 103, and a noise sample image 104. The second sample image is an image having a single damage type, and image quality of the first sample image is greater than image quality of the second sample image.

In some embodiments, the damage type includes at least one of a blur damage type, a noise damage type, and a bias damage type. This is not specifically limited in this embodiment of the present disclosure.

For example, the first sample image 101 is an image having high-resolution, or that does not affect expression of image content, or that has a small impact on expression of the image content. The blur sample image 102 is an image having blur content in the image. The noise sample image 104 is image content that is unnecessary or has a negative impact on analysis and understanding of image content, that is, image noise, and the image is the noise sample image 104. The bias sample image 103 is an image causing a luminance difference due to bias. The blur damage type, the noise damage type, and the bias damage type of the second sample image all may be set randomly.

For example, the computer device extracts a first feature corresponding to the first sample image 101 by using a first degradation encoder 105, and respectively extracts at least two second features corresponding to the at least two types of the second sample images.

The computer device extracts, based on the first feature and the second feature, a damage feature of the second feature by using a corresponding damage kernel extractor. The computer device adds the damage feature to the first feature of the first sample image 101, to obtain an intermediate first feature, and inputs the intermediate first feature to a first degradation decoder 109 for decoding processing, to obtain a single degradation image corresponding to the first sample image.

For example, the computer device extracts a feature of the first sample image 101 by using the first degradation encoder 105, to obtain the first feature. The computer device extracts features of the blur sample image 102, the noise sample image 104, and the bias sample image 103 respectively by using the first degradation encoder 105, to obtain a blur sample feature, a noise sample feature, and a bias sample feature respectively.

The computer device inputs the first feature and the blur sample feature to a blur kernel extractor 106 for feature extraction, to obtain a blur damage feature of the blur sample feature. The computer device inputs the first feature and the bias sample feature to a bias kernel extractor 107 for feature extraction, to obtain a bias damage feature of the bias sample feature. The computer device inputs the first feature and the noise sample feature to a noise kernel extractor 108 for feature extraction, to obtain a noise damage feature of the noise sample feature.

The computer device fuses the first feature corresponding to the first sample image 101 and the blur damage feature, to generate an intermediate first blur feature. The computer device performs decoding processing on the intermediate first blur feature by using the first degradation decoder 109, to generate a blur degradation image 110 corresponding to the first sample image 101.

The computer device fuses the first feature corresponding to the first sample image 101 and the bias damage feature, to generate an intermediate first bias feature. The computer device performs decoding processing on the intermediate first bias feature by using the first degradation decoder 109, to generate a bias degradation image 111 corresponding to the first sample image.

The computer device fuses the first feature corresponding to the first sample image 101 and the noise damage feature, to generate an intermediate first noise feature. The computer device performs decoding processing on the intermediate first noise feature by using the first degradation decoder 109, to generate a noise degradation image 112 corresponding to the first sample image.

For example, the computer device obtains at least two third features corresponding to the single degradation images by using a second degradation encoder 113, and fuses the third features, to obtain a degradation fusion feature. The computer device performs decoding processing on the degradation fusion feature by using a second degradation decoder 114, to generate a multiple degradation image 115 corresponding to the first sample image 101.

For example, the computer device performs feature extraction on the blur degradation image 110, the bias degradation image 111, and the noise degradation image 112 respectively by using the second degradation encoder 113, and performs feature fusion on a feature corresponding to the blur degradation image 110, a feature corresponding to the bias degradation image 111, and a feature corresponding to the noise degradation image 112, to obtain the degradation fusion feature. The computer device performs decoding processing on the degradation fusion feature by using the second degradation decoder 114, to generate the multiple degradation image 115 corresponding to the first sample image 101.

The computer device performs image reconstruction processing on the multiple degradation image based on a reconstruction encoder 116 and a reconstruction decoder 117 in a reconstruction network layer of the image reconstruction model, to generate a predicted reconstruction image 118 corresponding to the multiple degradation image 115.

For example, the computer device calculates a first loss function value based on the second feature corresponding to the second sample image and the third feature corresponding to the single degradation image. The first loss function value includes a first blur loss function value, a first bias loss function value, and a first noise loss function value.

For example, the computer device calculates the first blur loss function value based on the second feature corresponding to the blur sample image 102 and the third feature corresponding to the blur degradation image 110. The computer device calculates the first bias loss function value based on the second feature corresponding to the bias sample image 103 and the third feature corresponding to the bias degradation image 111. The computer device calculates the first noise loss function value based on the second feature corresponding to the noise sample image 104 and the third feature corresponding to the noise degradation image 112. Each first loss function value is used to measure a similarity between one of the second sample images and one of the single degradation images corresponding to the one second sample image.

For example, the computer device calculates a second loss function value based on the first feature corresponding to the first sample image 101 and a fourth feature corresponding to the predicted reconstruction image 118. The second loss function value is used to measure authenticity of the predicted reconstruction image.

For example, the computer device calculates a third loss function value based on a structural feature corresponding to the multiple degradation image 115 and a structural feature corresponding to the first sample image 101. The structural feature corresponding to the multiple degradation image 115 is a structural feature of a non-content part of the multiple degradation image 115. The third loss function value is used to measure a similarity between a non-content part in the multiple degradation image 115 and a non-content part in the first sample image 101.

For example, the computer device calculates a fourth loss function value based on a content feature and a texture feature that correspond to the first sample image 101 and a content feature and a texture feature that correspond to the predicted reconstruction image 118.

The fourth loss function value is used to measure a similarity between the first sample image and the predicted reconstruction image.

For example, the computer device updates a model parameter of the image reconstruction model based on a sum of the first loss function value, the second loss function value, the third loss function value, and the fourth loss function value.

In conclusion, the method provided in this embodiment, the damage feature corresponding to each second sample image of third second sample images are added respectively to the first sample image in the degradation network layer by obtaining the first sample image and the third second sample images, to generate third single degradation images. The third single degradation images are fused, to obtain the multiple degradation image corresponding to the first sample image. Then, image reconstruction processing is performed on the multiple degradation image in the reconstruction network layer, to generate the predicted reconstruction image corresponding to the multiple degradation image. The computer device calculates the loss function value based on the third second sample images, third single degradation images, the first sample image, and the predicted reconstruction image; and updates the model parameter of the image reconstruction model based on the loss function value. According to the training method of the image reconstruction model provided in the present disclosure, the image damage of a plurality of damage types is simultaneously performed on the first sample image, to obtain the multiple degradation image corresponding to the first sample image, and the multiple degradation image having the plurality of damage types is reconstructed through the reconstruction network layer. When the model obtained through training by using the foregoing method is used, a plurality of damage types of a low-quality image may be simultaneously reconstructed. This avoids an accumulated error caused by reconstructing the damage types of the low-quality image in sequence, and further improves image reconstruction precision of a trained image reconstruction model.

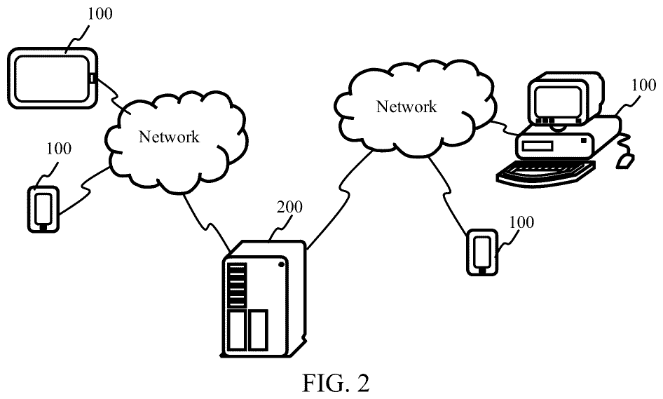

FIG. 2 is a schematic diagram of an architecture of a computer system according to an embodiment of the present disclosure. The computer system may include a terminal 100 and a server 200.

The terminal 100 may be an electronic device such as a mobile phone, a tablet computer, an in-vehicle terminal (in-vehicle infotainment), a wearable device, a personal computer (PC), an intelligent voice interaction device, a smart home appliance, an aerial vehicle, or an unmanned vending terminal. A client running a target application may be installed in the terminal 100. The target application may be an application for image reconstruction, or may be another application that provides an image reconstruction function. This is not limited in the present disclosure. In addition, a form of the target application is not limited in the present disclosure, and includes but is not limited to an application (App), an applet, and the like that are installed in the terminal 100, or may be in a form of a web page.

The server 200 may be an independent physical server, or a server cluster or a distributed system composed of a plurality of physical servers, or may alternatively be a cloud server that provides a cloud computing service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The server 200 may be a back-end server of the foregoing target application, and is configured to provide a background service for a client of the target application.

A cloud technology (Cloud technology) is a hosting technology that unifies a series of resources such as hardware, software, and a network in a wide area network or a local area network, to implement data computing, storage, processing, and sharing. A general term for a network technology, an information technology, an integration technology, a management platform technology, and an application technology that are applied based on a cloud computing business model. The cloud technology can form resource pools and be used on demand. A cloud computing technology is an important support. A background service of a technical network system needs a large quantity of computing and storage resources, such as a video website, an image website, and more portal websites. With the development and application of the internet industry, each item may have identification flag and needs to be transmitted to the background system for logic processing. Data of different levels is processed separately. Various industry data needs powerful system support, and this be implemented only through cloud computing.

In some embodiments, the server may be alternatively implemented as a node in a blockchain system. Blockchain (Blockchain) is a new application mode of a computer technology such as distributed data storage, point-to-point transmission, consensus mechanism, and an encryption algorithm. The blockchain is essentially a decentralized database, and is a string of a data block generated in a cryptographic manner. Each data block contains information about a batch of network transactions, which is used to verify validity of the information (anti-counterfeiting) and generate a next block. The blockchain may include a blockchain underlying platform, a platform product service layer, and an application service layer.

The terminal 100 and the server 200 may communicate with each other by using a network, for example, a wired or wireless network.

According to a training method of an image reconstruction model provided in embodiments of the present disclosure, operations may be performed by a computer device, and the computer device is an electronic device having a data calculation, processing, and storage capability. A solution implementation environment shown in FIG. 2 is used as an example. The terminal 100 may perform the training method of the image reconstruction model or an image reconstruction method (for example, the client of the target application installed and running on the terminal 100 performs the training method of the image reconstruction model or the image reconstruction method). Alternatively, the server 200 may perform the training method of the image reconstruction model or the image reconstruction method, or the terminal 100 and the server 200 interact and cooperate to perform the training method of the image reconstruction model or the image reconstruction method. This is not limited in the present disclosure.

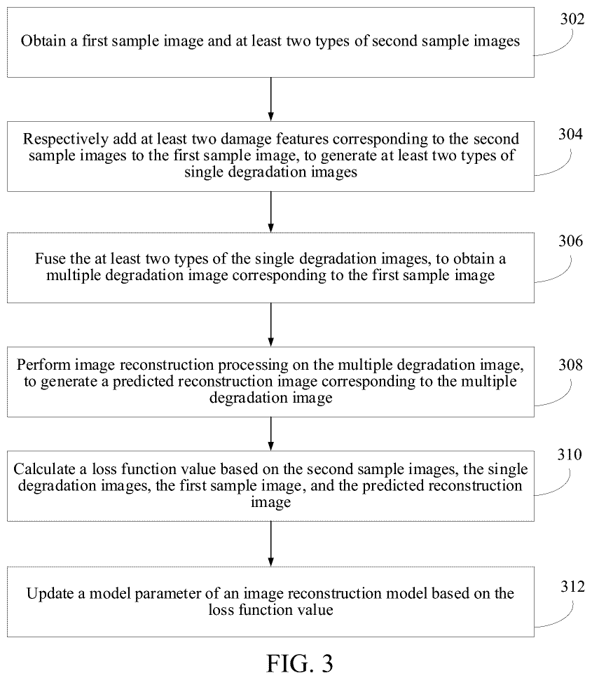

FIG. 3 is a flowchart of a training method of an image reconstruction model according to an exemplary embodiment of the present disclosure. The method may be executed by a computer device, where the computer device may be the terminal 100 or the server 200 in FIG. 2. The method includes the following operations.

Operation 302: Obtain a first sample image and at least two types of second sample images.

The second sample image is an image having a single damage type, and image quality of the first sample image is greater than image quality of the second sample image. The single damage type means that only one damage type is included. The damage type includes image blur, image bias, image noise, and the like. In some embodiments, the second sample image is obtained by performing an image degradation operation on the first sample image. In this case, the first sample image and the second sample image are different only in the image quality. In some embodiments, the second sample image is obtained by performing an image quality enhancement operation on the first sample image. In this case, the first sample image and the second sample image are different only in the image quality.

In some embodiments, the first sample image and the second sample image are obtained by photographing a same object by using different photographing parameters. In this case, the first sample image and the second sample image are different only in the image quality. The first sample image is obtained through photographing by using a correct photographing parameter, and the second sample image is obtained through photographing by using an incorrect photographing parameter. The correct photographing parameter and the incorrect photographing parameter respectively correspond to a high-quality image and a low-quality image.

For example, the first sample image is a high-resolution image, and the second sample image is a low-resolution image. The image in embodiments of the present disclosure may be a biological or non-biological internal tissue image that cannot be directly seen by human eyes and that is obtained in a non-intrusive manner. For example, in the biomedicine field, the image in embodiments of the present disclosure may be a biological image (for example, a medical image). The biological image is an image that is of an internal tissue of an organism or a part of the organism (for example, a human body or a part of the human body) and that is obtained in the non-intrusive manner for medicine or medical research. In an example, for the medical field, the image in embodiments of the present disclosure may be an image of a heart and a lung, a liver, a stomach, a large intestine and a small intestine, a human brain, a bone, a blood vessel, or the like; or may be an image of a non-human organ such as a tumor. In addition, the image in embodiments of the present disclosure may be an image generated based on an imaging technology such as an X-ray (X-ray) technology, a computed tomography (CT) technology, a positron emission tomography (PET) technology, a nuclear magnetic resonance imaging (NMRI) technology, or medical ultrasonography (Medical Ultrasonography). In addition, the image in embodiments of the present disclosure may alternatively be a what you see is what you get image generated by using a visual imaging technology, for example, an image photographed by using a camera lens (for example, a camera lens of a camera or a camera lens of a terminal).

Operation 304: Respectively add at least two damage features corresponding to the second sample images to the first sample image, to generate at least two types of single degradation images.

A feature is a corresponding (essential) trait or characteristic that distinguishes one type of object from another type of object, or a set of the traits or the characteristics. In one embodiment, the computer device may perform feature extraction on an image by using a machine learning model. The damage feature is a feature corresponding to a damaged part of the second sample image, for example, a feature corresponding to a blur part of the second sample image, and a feature corresponding to a noise part of the second sample image.

For example, the computer device extracts the at least two damage features corresponding to the second sample images, and respectively adds the damage feature corresponding to each second sample image to the first sample image, to generate the single degradation image, so that the generated single degradation image includes a damage feature that is the same as or similar to that of the second sample image. The single degradation image is an image obtained by adding the single damage type to the first sample image. For example, the computer device extracts a blur damage feature corresponding to the second sample image, and adds the blur damage feature to the first sample image, to obtain a blur degradation image corresponding to the first sample image.

Operation 306: Fuse the at least two types of the single degradation images, to obtain a multiple degradation image corresponding to the first sample image.

The multiple degradation image is an image having at least two damage types. For example, the computer device fuses the at least two single degradation images, to obtain an image having a plurality of damage types. For example, the single degradation image is a blur degradation image, a bias degradation image, and a noise degradation image. The computer device fuses the blur degradation image, the bias degradation image, and the noise degradation image, to generate the multiple degradation image, so that the generated multiple degradation image has the same or similar blur damage feature, noise damage feature, and bias damage feature.

Operation 308: Perform image reconstruction processing on the multiple degradation image, to generate a predicted reconstruction image corresponding to the multiple degradation image.

The image reconstruction processing means processing a damage feature of the multiple degradation image, for example, to reduce or remove the blur damage feature, the noise damage feature, and the bias damage feature of the multiple degradation image. The predicted reconstruction image is an image obtained by reducing or removing the damage feature of the multiple degradation image.

For example, the computer device performs reconstruction processing on the multiple degradation image, to reduce or remove the blur damage feature, the noise damage feature, and the bias damage feature of the multiple degradation image, to generate the predicted reconstruction image corresponding to the multiple degradation image.

Operation 310: Calculate a loss function value based on the second sample images, the single degradation images, the first sample image, and the predicted reconstruction image.

The loss function value obtained through calculation based on the second sample image, the single degradation image, the first sample image, and the predicted reconstruction image may be used to measure a training effect of the image reconstruction model. In some embodiments, the loss function value is at least one of a cross entropy, a mean square error, and an absolute difference, but is not limited thereto. This is not limited in embodiments of the present disclosure.

Operation 312: Update a model parameter of the image reconstruction model based on the loss function value.

Updating of the model parameter refers to updating a network parameter in the image reconstruction model, or updating a network parameter of each network module in the model, or updating a network parameter of each network layer in the model. However, this is not limited thereto. This is not limited in embodiments of the present disclosure.

In some embodiments, the model parameter of the image reconstruction model is adjusted based on the loss function value of the image reconstruction model until the image reconstruction model or a training system of the image reconstruction model meets a training stop condition, to obtain a trained image reconstruction model. In some embodiments, before the image reconstruction model or the training system of the image reconstruction model meets the training stop condition, a model parameter of another learning model in the training system of the image reconstruction model is also continuously adjusted based on a training loss.

In conclusion, according to the method provided in this embodiment, the first sample image and the at least two second sample images are obtained. The computer device respectively adds the at least two damage features corresponding to the second sample images to the first sample image, to generate at least two types of single degradation images. The computer device fuses the at least two single degradation images, to obtain the multiple degradation image corresponding to the first sample image; and performs the image reconstruction processing on the multiple degradation image, to generate the predicted reconstruction image corresponding to the multiple degradation image. The computer device calculates the loss function value based on the second sample images, the single degradation images, the first sample image, and the predicted reconstruction image. The computer device updates the model parameter of the image reconstruction model based on the loss function value. According to the training method of the image reconstruction model provided in the present disclosure, the image damage of a plurality of damage types is simultaneously performed on the first sample image, to obtain the multiple degradation image corresponding to the first sample image, and the multiple degradation image having the plurality of damage types is reconstructed through a reconstruction network layer. When the model obtained through training by using the foregoing method is used, a plurality of damage types of a low-quality image may be simultaneously reconstructed. This avoids an accumulated error caused by reconstructing the damage types of the low-quality image in sequence, and further improves image reconstruction precision of the trained image reconstruction model.

An embodiment of the present disclosure provides an image reconstruction model. The image reconstruction model includes a degradation network layer and a reconstruction network layer.

A computer device obtains a first sample image and at least two types of second sample images; respectively adds, through the degradation network layer, at least two damage features corresponding to the second sample images to the first sample image, to generate at least two types of single degradation images; and fuses the at least two single degradation images, to obtain a multiple degradation image corresponding to the first sample image. The computer device performs image reconstruction processing on the multiple degradation image through the reconstruction network layer, to generate a predicted reconstruction image corresponding to the multiple degradation image.

Based on the image reconstruction model, the following training method of the image reconstruction model is provided.

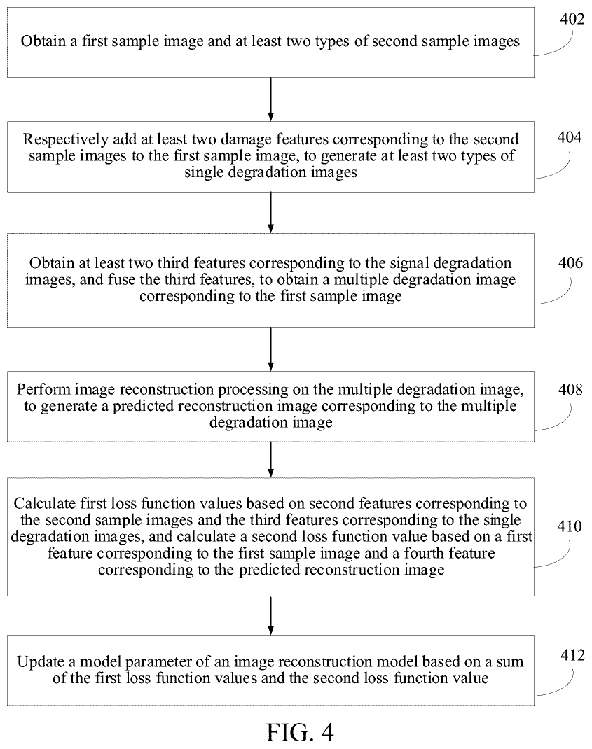

FIG. 4 is a flowchart of a training method of an image reconstruction model according to an exemplary embodiment of the present disclosure. The method may be executed by a computer device, where the computer device may be the terminal 100 or the server 200 in FIG. 2. The method includes the following operations.

Operation 402: Obtain a first sample image and at least two types of second sample images.

The first sample image is an image having a high-resolution, or having a damage type but does not affect expression of image content, or having a damage type but having a small impact on expression of image content. The second sample image is an image having a single damage type, and image quality of the first sample image is greater than image quality of the second sample image.

In some embodiments, the damage type includes at least one of a blur damage type, a noise damage type, and a bias damage type. This is not limited in this embodiment of the present disclosure.

The second sample image may be any one of a blur sample image, a noise sample image, or a bias sample image. The blur sample image is an image having blur content in the image. The noise sample image is image content that is unnecessary or has a negative impact on analysis and understanding of image content, that is, image noise, and the image is the noise sample image. The bias sample image is an image causing a luminance difference due to bias. For example, an artifact (that is, image noise) generated due to interference of a metal object usually occurs in a medical image. This may affect determining of a doctor.

Operation 404: Respectively add at least two damage features corresponding to the second sample images to the first sample image, to generate at least two types of single degradation images.

The damage feature is a feature corresponding to a damaged part of the second sample image, for example, a feature corresponding to a blur part of the second sample image, and a feature corresponding to a noise part of the second sample image.

The single degradation image is an image obtained by adding the single damage type to the first sample image.

For example, the computer device obtains a first feature corresponding to the first sample image, and respectively obtains at least two second features corresponding to the at least two types of the second sample images. The computer device obtains, based on the first feature and the one second feature, a damage feature corresponding to one of the second sample images. The computer device adds the damage feature to the first feature of the first sample image, to obtain one of the single degradation images corresponding to the first sample image. The first feature represents an image feature of the first sample image, and the second feature represents an image feature of one of the second sample images.

For example, the image reconstruction model includes a degradation network layer, and the degradation network layer includes a first degradation encoder, a damage kernel extractor, and a first degradation decoder.

The computer device extracts the first feature corresponding to the first sample image by using the first degradation encoder, and respectively extracts at least two second features corresponding to the at least two types of the second sample images.

The computer device determines the damage feature by comparing the first feature and one of the second features, and performs decoupling by using the damage kernel extractor, to obtain, from the one second feature, the damage feature corresponding to the one of the second sample images. The computer device adds the damage feature to the first feature of the first sample image, to obtain an intermediate first feature; and inputs the intermediate first feature to the first degradation decoder for decoding processing, to obtain one of the single degradation images corresponding to the first sample image.

For example, the second sample image is a blur sample, a noise sample image, and a bias sample image. The computer device extracts a feature of the first sample image by using the first degradation encoder, to obtain the first feature. The computer device extracts features of the blur sample image, the noise sample image, and the bias sample image respectively by using the first degradation encoder, to obtain a blur sample feature, a noise sample feature, and a bias sample feature respectively.

The computer device inputs the first feature and the blur sample feature to a blur kernel extractor for feature extraction, to obtain a blur damage feature of the blur sample feature. The computer device inputs the first feature and the bias sample feature to a bias kernel extractor for feature extraction, to obtain a bias damage feature of the bias sample feature. The computer device inputs the first feature and the noise sample feature to a noise kernel extractor for feature extraction, to obtain a noise damage feature of the noise sample feature.

The computer device fuses the first feature corresponding to the first sample image and the blur damage feature, to generate an intermediate first blur feature. The computer device performs decoding processing on the intermediate first blur feature by using the first degradation decoder, to generate a blur degradation image corresponding to the first sample image.

The computer device fuses the first feature corresponding to the first sample image and the bias damage feature, to generate an intermediate first bias feature. The computer device performs decoding processing on the intermediate first bias feature by using the first degradation decoder, to generate a bias degradation image corresponding to the first sample image.

The computer device fuses the first feature corresponding to the first sample image and the noise damage feature, to generate an intermediate first noise feature. The computer device performs decoding processing on the intermediate first noise feature by using the first degradation decoder, to generate a noise degradation image corresponding to the first sample image.

Operation 406: Obtain at least two third features corresponding to the single degradation images, and fuse the third features, to obtain the multiple degradation image corresponding to the first sample image.

The multiple degradation image is an image having at least two damage types.

The third feature represents an image feature of one of the single degradation images.

For example, the degradation network layer of the image reconstruction model further includes a second degradation encoder and a second degradation decoder. The computer device obtains the at least two third features corresponding to the single degradation images by using the second degradation encoder, and fuses the third features, to obtain a degradation fusion feature. The computer device performs decoding processing on the degradation fusion feature by using the second degradation decoder, to generate the multiple degradation image corresponding to the first sample image.

For example, the single degradation image is a blur degradation image, a bias degradation image, and a noise degradation image. The computer device performs feature extraction on the blur degradation image, the bias degradation image, and the noise degradation image respectively by using the second degradation encoder, and performs feature fusion on a feature corresponding to the blur degradation image, a feature corresponding to the bias degradation image, and a feature corresponding to the noise degradation image, to obtain a degradation fusion feature. The computer device performs decoding processing on the degradation fusion feature by using the second degradation decoder, to generate the multiple degradation image corresponding to the first sample image.

Operation 408: Perform image reconstruction processing on the multiple degradation image, to generate a predicted reconstruction image corresponding to the multiple degradation image.

The image reconstruction processing means processing a damage feature of the multiple degradation image, to reduce or remove the blur damage feature, the noise damage feature, and the bias damage feature of the multiple degradation image.

The predicted reconstruction image is an image obtained by reducing or removing the damage feature of the multiple degradation image.

For example, the image reconstruction model includes a reconstruction network layer, and the reconstruction network layer includes a reconstruction encoder and a reconstruction decoder. The computer device inputs the multiple degradation image to the reconstruction encoder for feature extraction, to obtain an image reconstruction feature. The computer device performs decoding processing on the image reconstruction feature by using the reconstruction decoder, to generate the predicted reconstruction image corresponding to the multiple degradation image.

Operation 410: Calculate first loss function values based on the second features corresponding to the second sample images and the third features corresponding to the single degradation images, and calculate a second loss function value based on the first feature corresponding to the first sample image and a fourth feature corresponding to the predicted reconstruction image.

The fourth represents an image feature of the predicted reconstruction image.

The first loss function value and the second loss function value that are obtained through calculation based on the second sample image, the single degradation image, the first sample image, and the predicted reconstruction image may be used to measure a training effect of the image reconstruction model.

In some embodiments, the loss function value is at least one of a cross entropy, a mean square error, and an absolute difference, but is not limited thereto. This is not limited in embodiments of the present disclosure.

The first loss function value is used to measure a similarity between the second sample image and the single degradation image corresponding to the second sample image.

For example, the computer device calculates the first loss function value based on the second feature corresponding to the second sample image and the third feature corresponding to the single degradation image. The first loss function value includes a first blur loss function value, a first bias loss function value, and a first noise loss function value.

In some embodiments, the computer device calculates an i^{th} first loss function value of the first loss function values based on a second feature corresponding to an i^{th} second sample image of the at least two second sample images and a third feature corresponding to an i^{th} single degradation image of the at least two single degradation images, where i is a positive integer.

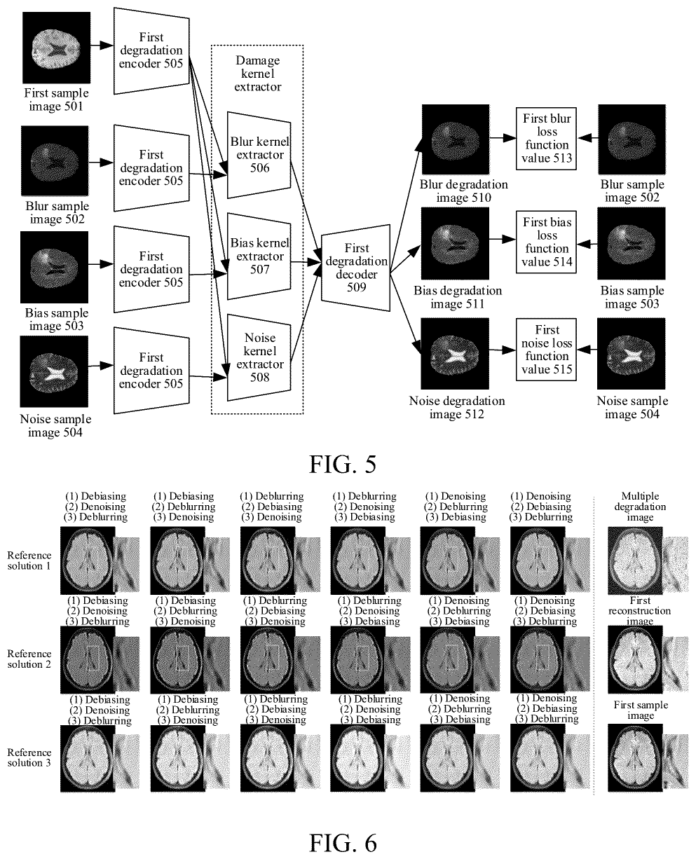

For example, as shown in FIG. 5, a computer device extracts a feature of a first sample image 501 by using a first degradation encoder 505, to obtain a first feature. The computer device extracts features of a blur sample image 502, a noise sample image 504, and a bias sample image 503 respectively by using the first degradation encoder 505, to obtain a blur sample feature, a noise sample feature, and a bias sample feature respectively. The computer device inputs the first feature and the blur sample feature to a blur kernel extractor 506 for feature extraction, to obtain a blur damage feature of the blur sample feature. The computer device inputs the first feature and the bias sample feature to a bias kernel extractor 507 for feature extraction, to obtain a bias damage feature of the bias sample feature. The computer device inputs the first feature and the noise sample feature to a noise kernel extractor 508 for feature extraction, to obtain a noise damage feature of the noise sample feature.

The computer device fuses the first feature corresponding to the first sample image 501 and the blur damage feature, to generate an intermediate first blur feature. The computer device performs decoding processing on the intermediate first blur feature by using a first degradation decoder 509, to generate a blur degradation image 510 corresponding to the first sample image 501. The computer device fuses the first feature corresponding to the first sample image 501 and the bias damage feature, to generate an intermediate first bias feature. The computer device performs decoding processing on the intermediate first bias feature by using the first degradation decoder 509, to generate a bias degradation image 511 corresponding to the first sample image 501. The computer device fuses the first feature corresponding to the first sample image 501 and the noise damage feature, to generate an intermediate first noise feature. The computer device performs decoding processing on the intermediate first noise feature by using the first degradation decoder 509, to generate a noise degradation image 512 corresponding to the first sample image 501.

The computer device calculates a first blur loss function value 513 based on a second feature corresponding to the blur sample image 502 and the third feature corresponding to the blur degradation image 510.

The computer device calculates a first bias loss function value 514 based on a second feature corresponding to the bias sample image 503 and a third feature corresponding to the bias degradation image 511.

The computer device calculates a first noise loss function value 515 based on a second feature corresponding to the noise sample image 504 and a third feature corresponding to the noise degradation image 512.

For example, a calculation formula of the first loss function value may be represented as:

$${de}_{} = {\sum }_{i = 1}^{N} {\sum }_{r = 1}^{R} E ( {y}_{i}^{( r )} , Ψ ( {x}_{i} , K ( {x}_{i} , {y}_{i}^{( r )} ) ) ) ;$$

In the formula, [symbol] _{de} is the first loss function value, N is a quantity of data groups, R is a quantity of damage types, r represents the damage type, x is the first sample image, y is the second sample image, K is the damage kernel extractor, ψ is the first degradation decoder, and E is a Charbonnier loss function.

The second loss function value is used to measure authenticity of the predicted reconstruction image.

For example, the computer device calculates the second loss function value based on the first feature corresponding to the first sample image and the fourth feature corresponding to the predicted reconstruction image.

To make a generated image closer to a real image, in embodiments of the present disclosure, a generative adversarial idea is used, and the first sample image and the predicted reconstruction image are input to a discriminator for discrimination, to obtain a discrimination result. The discriminator is configured to discriminate the first sample image and the predicted reconstruction image. An adversarial loss is determined based on the discrimination result, that is, the second loss function value is determined. Finally, when the discriminator cannot distinguish whether the given image is the first sample image or the predicted reconstruction image, that is, the predicted reconstruction image is close to the first sample image, training is completed.

For example, a calculation formula of the second loss function value may be represented as:

$${up}_{} = E [ log {D}_{up} ( x ) ] + E [ log ( 1 - {D}_{up} ( {G}_{up} ( \hat{y} ) ) ) ] ;$$

In the formula, [symbol] ᵤₚ is the second loss function value, E is the Charbonnier loss function, Dᵤₚ is the discriminator, x is the first sample image, ŷ is the multiple degradation image, and is Gᵤₚ a reconstruction network layer.

In one embodiment, the loss function value further includes a third loss function value and a fourth loss function value.

The third loss function value is used to measure a similarity between a non-content part in the multiple degradation image and a non-content part in the first sample image.

For example, the third loss function value is calculated based on a structural feature corresponding to the multiple degradation image and a structural feature corresponding to the first sample image.

For example, a calculation formula of the third loss function value may be represented as:

$${cde}_{} = {‖ {T}_{de}^{l} ( {\hat{y}}_{i} ) - {T}_{de}^{l} ( {x}_{i} ) ‖}_{1}^{1} ;$$

In the formula, [symbol] _{cde} is the third loss function value, xᵢ is an i^{th} first sample image, ŷᵢ is the i^{th} multiple degradation image, and T_{de}^{l} is a feature representation of an l^{th} layer of the image.

The fourth loss function value is used to measure a similarity between the first sample image and the predicted reconstruction image.

For example, the fourth loss function value is calculated based on a content feature and a texture feature that correspond to the first sample image and a content feature and a texture feature that correspond to the predicted reconstruction image. In some embodiments, the content feature is a pixel value of each pixel in the image, for example, luminance and brightness of each pixel.

For example, a calculation formula of the fourth loss function value may be represented as:

$${TS}_{} = {cup}_{} ( {G}_{up} , {\hat{x}}_{i} , {x}_{i} ) + λ {texture}_{} ( {G}_{up} , {\hat{x}}_{i} , {x}_{i} ) ;$$

In the formula, [symbol] _{TS} is the fourth loss function value, xᵢ is the i^{th} first sample image, \hat{x}ᵢ is an i^{th} predicted reconstruction image, Gᵤₚ is the reconstruction network layer, [symbol] _{cup} is a content loss function value, [symbol] ₜₑₓₜᵤᵣₑ is a texture loss function value, and λ is a weight value. For example, λ is 0.9.

Operation 412: Update a model parameter of the image reconstruction model based on a sum of the first loss function value and the second loss function value.

Updating of the model parameter refers to updating a network parameter in the image reconstruction model, or updating a network parameter of each network module in the model, or updating a network parameter of each network layer in the model. However, this is not limited thereto. This is not limited in embodiments of the present disclosure.

In one embodiment, the computer device updates the model parameter of the image reconstruction model based on a sum of the first loss function value, the second loss function value, the third loss function value, and the fourth loss function value.

For example, a linear combination constructed based on the sum of the first loss function value, the second loss function value, the third loss function value, and the fourth loss function value may be represented as:

$$= {de}_{} + α {cde}_{} + {up}_{} + β {TS}_{} ;$$

In the formula, & is the loss function value, [symbol] _{de} is the first loss function value, [symbol] _{cde} is the third loss function value, [symbol] ᵤₚ is the second loss function value, [symbol] _{TS} is the fourth loss function value, and α and β are weight factors. For example, α=400, and β=100.

The model parameter of the image reconstruction model includes at least one of a network parameter of the first degradation encoder, a network parameter of the damage kernel extractor, a network parameter of the first degradation decoder, a network parameter of the second degradation encoder, and a network parameter of the second degradation decoder, a network parameter of the reconstruction encoder, and a network parameter of the reconstruction decoder.

When the loss function value is obtained, the computer device updates, based on the loss function value, the network parameter of the first degradation encoder, the network parameter of the damage kernel extractor, the network parameter of the first degradation decoder, the network parameter of the second degradation encoder, and the network parameter of the second degradation decoder, the network parameter of the reconstruction encoder, and the network parameter of the reconstruction decoder that are of the image reconstruction model, to obtain an updated first degradation encoder, an updated damage kernel extractor, an updated first degradation decoder, an updated second degradation encoder, an updated second degradation decoder, an updated reconstruction encoder, and an updated reconstruction decoder, and to obtain the trained image reconstruction model.

In some embodiments, updating of the model parameter of the image reconstruction model includes that network parameters of all network modules in the image reconstruction model are updated, or network parameters of some network modules of the image reconstruction model are fixed, and network parameters of only remaining network modules are updated. For example, when the model parameter of the image reconstruction model is updated, the network parameter of the first degradation encoder, network parameter of the second degradation encoder, and the network parameter of the reconstruction encoder that are of the image reconstruction model are fixed, and only the network parameter of the damage kernel extractor, the network parameter of the first degradation decoder, the network parameter of the second degradation decoder, and the network parameter of the reconstruction decoder are updated.

In conclusion, according to the method provided in this embodiment, the first sample image and the at least two second sample images are obtained. The computer device respectively adds the at least two damage features corresponding to the second sample images to the first sample image, to generate at least two types of single degradation images. The computer device fuses the at least two single degradation images, to obtain the multiple degradation image corresponding to the first sample image; and performs image reconstruction processing on the multiple degradation image, to generate the predicted reconstruction image corresponding to the multiple degradation image. The computer device calculates the first loss function value, the second loss function value, the third loss function value, and the fourth loss function value based on the second sample images, the single degradation images, the first sample image, and the predicted reconstruction image. The computer device updates the model parameter of the image reconstruction model based on a sum of the first loss function value, the second loss function value, the third loss function value, and the fourth loss function value. According to the training method of the image reconstruction model provided in the present disclosure, the image damage of a plurality of damage types is simultaneously performed on the first sample image, to obtain the multiple degradation image corresponding to the first sample image, and the multiple degradation image having the plurality of damage types is reconstructed through the reconstruction network layer. When the model obtained through training by using the foregoing method is used, a plurality of damage types of a low-quality image may be simultaneously reconstructed. This avoids an accumulated error caused by reconstructing the damage types of the low-quality image in sequence, and further improves image reconstruction precision of the trained image reconstruction model.

FIG. 6 is a schematic diagram of a reconstruction effect of an image reconstruction model according to an exemplary embodiment of the present disclosure.

In the medical field, a medical image is an important auxiliary tool for medical auxiliary diagnosis. Image reconstruction is performed on the medical image, and detailed information in the medical image is displayed more clearly based on an image reconstruction result, so that medical personnel can better assist in the medical diagnosis. As shown in FIG. 6, comparison effects between the solutions and the reference solutions that are provided in the present disclosure are compared by designing a comparison experiment. An MNIST data set is used in the experiment. The reference solutions include a reference solution 1, a reference solution 2, and a reference solution 3. In the reference solution, denoising processing, deblurring processing and debiasing processing are performed on a multiple degradation image, but a processing sequence is different.

For example, in the reference solution 1, denoising processing, deblurring processing, and debiasing processing are performed on the multiple degradation image by selecting different processing sequences, to finally obtain six groups of image reconstruction results. The six groups of image reconstruction results in the reference solution 1 are compared with a first sample image, and a predicted reconstruction image obtained based on the solution provided in the present disclosure is compared with the first sample image, to obtain that the solution provided in the present disclosure can generate a more realistic image reconstruction result having a higher visual effect for the medical image.

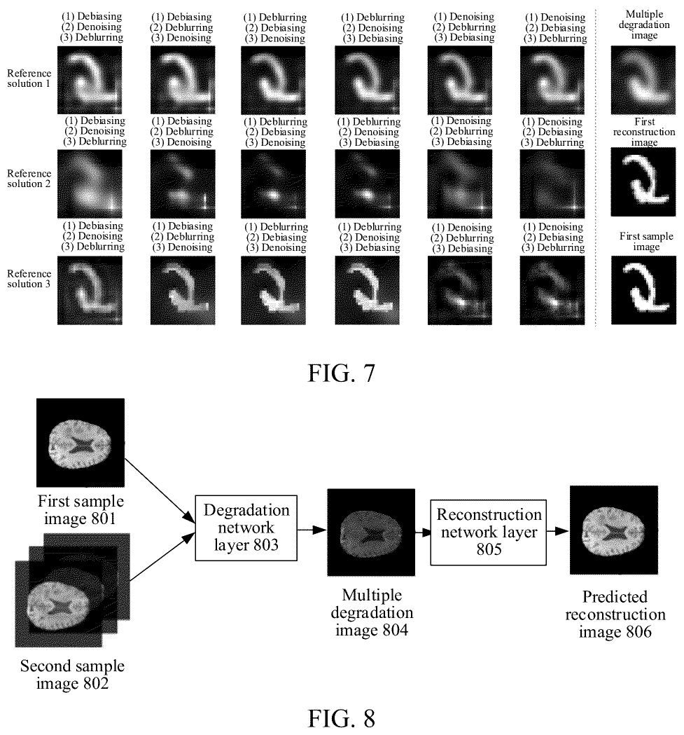

In the field of image defect repair, a high-quality image can reflect the more realistic view, and provide the higher visual effect. As shown in FIG. 7, the comparison effects between the solutions and the reference solutions that are provided in the present disclosure are compared by designing the comparison experiment. The MNIST data set is used in the experiment. The reference solutions include the reference solution 1, the reference solution 2, and the reference solution 3. In the reference solution, denoising processing, deblurring processing and debiasing processing are performed on the multiple degradation image, but the processing sequence is different.

For example, for different reference solutions, denoising processing, deblurring processing, and debiasing processing are performed on the multiple degradation image by selecting different processing sequences, to finally obtain six groups of image reconstruction results for each reference solution. The six groups of image reconstruction results in different reference solutions are compared with the first sample image, and the predicted reconstruction image obtained based on the solution provided in the present disclosure is compared with the first sample image, to obtain that the solution provided in the present disclosure can achieve a better defect repair effect for a defective image.

FIG. 8 is a schematic diagram of a training method of an image reconstruction model according to an exemplary embodiment of the present disclosure. The method may be executed by a computer device, where the computer device may be the terminal 100 or the server 200 in FIG. 2. The method includes the following operations.

In the medical field, a medical image is an important auxiliary tool for medical auxiliary diagnosis. Image reconstruction is performed on the medical image, and detailed information in the medical image is displayed more clearly based on an image reconstruction result, so that medical personnel can better assist in the medical diagnosis. As shown in FIG. 8, a first sample image 801 and at least two second sample images 802 are input to a degradation network layer 803 to perform image degradation operation on the first sample image 801, to obtain an image reconstruction result, that is, a multiple degradation image 804.

Image degradation refers to that in a process of forming, recording, processing, and transmitting an image, image quality deteriorates due to imperfection of an imaging system, a recording device, transmission media, and a processing method. This phenomenon refers to as image degradation.

In this embodiment of the present disclosure, image degradation processing performed on the first sample image 801 is to simultaneously add a plurality of damage types to the first sample image 801 simultaneously. For example, random blurring processing, random noising processing, and random bias processing are added to the first sample image 801, that is, a plurality of types of defects are added to the first sample image 801.

When image reconstruction is performed on the multiple degradation image 804, a reconstruction network layer 805 simultaneously reconstructs the plurality of types of defects of the multiple degradation image 804, that is, deblurring, denoising, and debiasing. The reconstruction network layer 805 reconstructs the multiple degradation image 804 into a high-quality image, that is, a predicted reconstruction image 806.

In the image reconstruction processing, accuracy of the image reconstruction affects accuracy of information display in the medical image, and further affects accuracy of the medical diagnosis performed by medical personnel based on display information. Therefore, in a medical image-assisted diagnosis scenario, the image reconstruction model obtained by using the training method of the image reconstruction model provided in the present disclosure can improve the accuracy of the image reconstruction performed on the medical image, display more clearly detailed information in the medical image, and improve accuracy of medical-assisted diagnosis.

The training method of the image reconstruction model in the present disclosure may be implemented based on the image reconstruction model. The solution includes a generation phase of an image reconstruction model and an image reconstruction phase. FIG. 9 is a framework diagram of generation of an image reconstruction model and image reconstruction according to an exemplary embodiment of the present disclosure. As shown in FIG. 9, in a generation phase of an image reconstruction model, after obtaining an image reconstruction model by using a preset training sample data set (including a first sample image and at least two types of second sample images), a device 910 for generating an image reconstruction model generates an image reconstruction result based on the image reconstruction model. In an image reconstruction phase, an image reconstruction device 920 processes an input first image based on the image reconstruction model, to obtain an image reconstruction result of the first image.

The device 910 for generating an image reconstruction model and the image reconstruction device 920 may be a computer device. For example, the computer device may be a fixed computer device such as a personal computer or a server, or the computer device may be a mobile computer device such as a tablet computer or an e-book reader.

In some embodiments, the device 910 for generating an image reconstruction model and the image reconstruction device 920 may be a same device, or the device 910 for generating an image reconstruction model and the image reconstruction device 920 may be different devices. In addition, when the device 910 for generating an image reconstruction model and the image reconstruction device 920 are different devices, the device 910 for generating an image reconstruction model and the image reconstruction device 920 may be devices of a same type. For example, both the device 910 for generating an image reconstruction model and the image reconstruction device 920 may be a server. Alternatively, the device 910 for generating an image reconstruction model and the image reconstruction device 920 may be different types of devices. For example, the image reconstruction device 920 may be the personal computer or a terminal, and the device 910 for generating an image reconstruction model may be the server. Specific types of the device 910 for generating an image reconstruction model and the image reconstruction device 920 are not limited in this embodiment of the present disclosure.

The training method of the image reconstruction model is described in the foregoing embodiments, and the following describes the image reconstruction method.

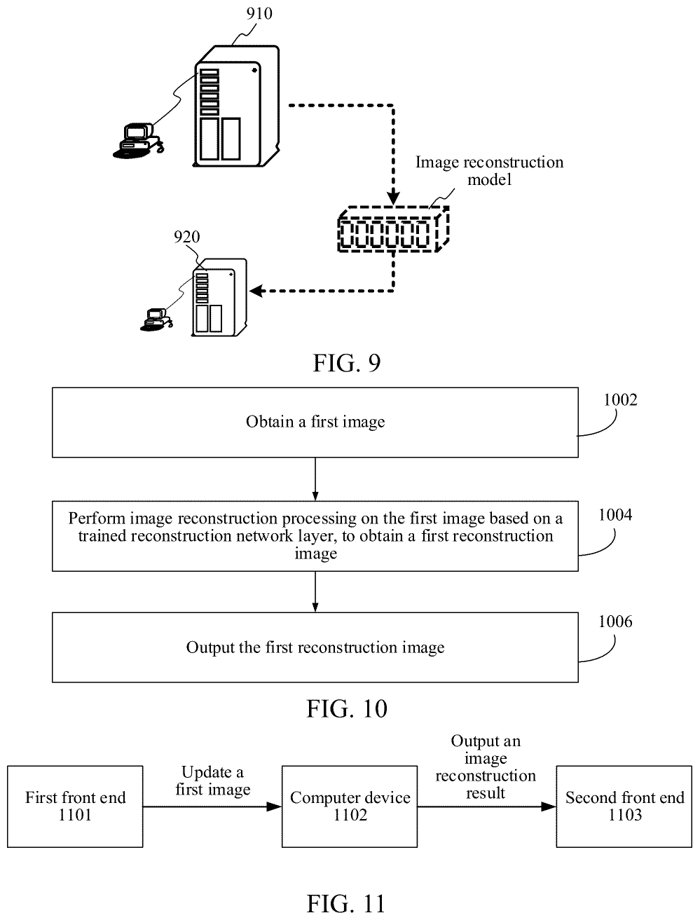

FIG. 10 is a flowchart of an image reconstruction method according to an exemplary embodiment of the present disclosure. The method may be executed by a computer device, where the computer device may be the terminal 100 or the server 200 in FIG. 2. The method includes the following operations.

Operation 1002: Obtain a first image.

The first image is an image having a plurality of damage types.

A method of obtaining the first image includes at least one of the following situations:

1. The computer device receives the first image. For example, the terminal is a terminal that initiates image scanning, the terminal scans a picture, and sends the first image to the server after completing the scanning.

2. The computer device obtains the first image from a stored database, for example, obtains at least one first image from an MNIST segmentation data set or a disclosed brain MRI data set. The foregoing method of obtaining the first image is merely an example. This is not limited in this embodiment of the present disclosure.

Operation 1004: Perform image reconstruction processing on the first image based on a trained reconstruction network layer, to obtain a first reconstruction image.

The computer device performs image reconstruction processing on the first image based on the trained reconstruction network layer. To be specific, the reconstruction network layer simultaneously reconstructs a plurality of types of defects of the first image, that is, deblurring, denoising, and debiasing. The reconstruction network layer reconstructs the first image into a high-quality image, that is, the first reconstruction image.

Operation 1006: Output the first reconstruction image.

The computer device outputs the first reconstruction image.

To verify an effect of the image reconstruction model obtained through training in the solutions provided in embodiments of the present disclosure, comparison effects between the solutions and the reference solutions that are provided in the present disclosure are compared by designing a comparison experiment. The MNIST data set is used in the experiment. The MNIST data set includes 60,000 training samples and 10,000 test examples. All images are in a size of 28×28. All images are pre-registered. All images are divided into 90% for training and 10% for testing, and 20% of the training images are retained as a validation set of two data sets.

Reference solutions include a reference solution 1, a reference solution 2, and a reference solution 3. In the reference solution, denoising (DN) processing, deblurring (DB) processing, and N4 bias correction are performed on a low-quality image, but processing sequence is different. Evaluation indicators used are respectively a peak signal to noise ratio (PSNR) and a structural similarity (SSIM), and are used to evaluate an image reconstruction effect.

TABLE 1
Comparison of average performance of repair methods in
different solutions and different sequences

| | Reconstruction sequence | | | Solution of |
|---|---|---|---|---|
| | N4 + DB + DN | DN + N4 + DB | DN + DB + N4 | the present |
| | N4 + DN + DB | DB + N4 + DN | DB + DN + N4 | disclosure |
| Reference solution 1 | | | | |
| Peak signal | 26.18 ± 0.47 | 26.37 ± 0.49 | 27.97 ± 0.58 | 35.52 ± 0.32 |
| to noise | 25.63 ± 0.52 | 27.37 ± 0.62 | 27.41 ± 0.43 | |
| ratio PSNR | | | | |
| Structural | 0.8346 ± 0.0026 | 0.8613 ± 0.0049 | 0.8691 ± 0.0034 | 0.9482 ± 0.0024 |
| similarity | | | | |
| SSIM | 0.8482 ± 0.0039 | 0.8549 ± 0.0025 | 0.8975 ± 0.0041 | |
| Reference solution 2 | | | | |
| Peak signal | 22.59 ± 0.58 | 21.86 ± 0.44 | 23.24 ± 0.38 | 35.52 ± 0.32 |
| to noise | 24.59 ± 0.62 | 22.37 ± 0.49 | 23.61 ± 0.41 | |
| ratio PSNR | | | | |
| Structural | 0.7785 ± 0.0046 | 0.7826 ± 0.0049 | 0.7891 ± 0.0051 | 0.9482 ± 0.0024 |
| similarity | 0.7962 ± 0.0039 | 0.7638 ± 0.0037 | 0.7623 ± 0.0042 | |
| SSIM | | | | |
| Reference solution 3 | | | | |
| Peak signal | 28.64 ± 0.38 | 25.73 ± 0.46 | 25.61 ± 0.29 | 35.52 ± 0.32 |
| to noise | 26.39 ± 0.41 | 30.12 ± 0.28 | 31.27 ± 0.33 | |
| ratio PSNR | | | | |
| Structural | 0.8342 ± 0.0043 | 0.8024 ± 0.0036 | 0.7993 ± 0.0029 | 0.9482 ± 0.0024 |
| similarity | 0.8007 ± 0.0058 | 0.8879 ± 0.0034 | 0.9046 ± 0.0053 | |
| SSIM | | | | |

Experiment results are shown in Table 1. It can be learned from Table 1 that, in the reconstruction result of the solution provided in the present disclosure, a PSNR implemented on the MNIST data set is 35.52 dB, the SSIM is 0.9482, and performance on the data set is better than performance of the reference solution, and has high applicability and stability.

In conclusion, according to the method provided in this embodiment, the first image is obtained, and image reconstruction processing is performed on the first image based on the trained reconstruction network layer, to obtain a high-quality first reconstruction image. In the present disclosure, an accurate image reconstruction result may be obtained based on the trained reconstruction network layer.

FIG. 11 is a schematic diagram of an image reconstruction method according to an exemplary embodiment of the present disclosure. The method may be executed by a computer device, where the computer device may be the terminal 100 or the server 200 in FIG. 2. The method includes the following operations.

When a first front end 1101 receives a first image that needs to be reconstructed, the first image is an image having a plurality of damage types. The first front end 1101 uploads the first image to a computer device 1102 for image reconstruction processing. For an image reconstruction processing process of the computer device 1102 on the first image, refer to the description in the foregoing embodiments. Details are not described herein again.

After the computer device 1102 performs image reconstruction processing on the first image, the computer device 1102 outputs an image reconstruction result to a second front end 1103.

In some embodiments, the first front end 1101 and the second front end 1103 may be a same front end, or may be different front ends. This is not limited in this embodiment of the present disclosure.

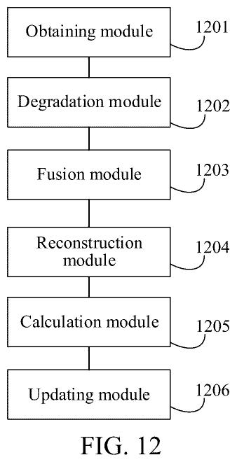

FIG. 12 is a schematic diagram of a structure of a training apparatus of an image reconstruction model according to an exemplary embodiment of the present disclosure. The apparatus may be implemented as all or a part of a computer device by using software, hardware, or a combination of the software and the hardware. The apparatus includes:
an obtaining module 1201, configured to obtain a first sample image and at least two types of second sample images, where the second sample image is an image having a single damage type, and image quality of the first sample image is greater than image quality of the second sample image;
a degradation module 1202, configured to respectively add at least two damage features corresponding to the second sample images to the first sample image, to generate at least two types of single degradation images;
a fusion module 1203, configured to fuse the at least two single degradation images, to obtain a multiple degradation image corresponding to the first sample image, where the multiple degradation image is an image having at least two damage types;
a reconstruction module 1204, configured to perform image reconstruction processing on the multiple degradation image, to generate a predicted reconstruction image corresponding to the multiple degradation image;
a calculation module 1205, configured to calculate a loss function value based on the second sample images, the single degradation images, the first sample image, and the predicted reconstruction image; and
an updating module 1206, configured to update a model parameter of the image reconstruction model based on the loss function value.

In one embodiment, the degradation module 1202 is further configured to: obtain a first feature corresponding to the first sample image; respectively obtain at least two second features corresponding to the at least two types of the second sample images; obtain, based on the first feature and the one second feature, a damage feature corresponding to one of the second sample images; and add the damage feature to the first feature of the first sample image, to obtain one of the single degradation images corresponding to the first sample image.

The image reconstruction model includes a degradation network layer, and the degradation network layer includes a first degradation encoder, a damage kernel extractor, and a first degradation decoder.

In one embodiment, the degradation module 1202 is further configured to: extract the first feature corresponding to the first sample image by using the first degradation encoder; respectively extract the at least two second features corresponding to the at least two types of the second sample images by using the first degradation encoder; determine the damage feature by comparing the first feature and the second feature; perform decoupling by using the damage kernel extractor, to obtain, from the one second feature, the damage feature corresponding to the one of the second sample images; add the damage feature to the first feature of the first sample image, to obtain an intermediate first feature; and input the intermediate first feature to the first degradation decoder for decoding processing, to obtain one of the single degradation images corresponding to the first sample image.

In one embodiment, the fusion module 1203 is further configured to: obtain at least two third features corresponding to the single degradation images; and fuse the third feature, to obtain the multiple degradation image corresponding to the first sample image.

A degradation network layer of the image reconstruction model further includes a second degradation encoder and a second degradation decoder.

In one embodiment, the fusion module 1203 is further configured to: obtain the at least two third features corresponding to the single degradation images by using the second degradation encoder; fuse the third features, to obtain a degradation fusion feature; and perform decoding processing on the degradation fusion feature by using the second degradation decoder, to generate the multiple degradation image corresponding to the first sample image.

The image reconstruction model includes a reconstruction network layer, and the reconstruction network layer includes a reconstruction encoder and a reconstruction decoder.

In one embodiment, the reconstruction module 1204 is further configured to: input the multiple degradation image to the reconstruction encoder for feature extraction, to obtain an image reconstruction feature; and perform decoding processing on the image reconstruction feature by using the reconstruction decoder, to generate the predicted reconstruction image corresponding to the multiple degradation image.

The loss function value includes a first loss function value and a second loss function value, the first loss function value is used to measure a similarity between the second sample image and the single degradation image corresponding to the second sample image, and the second loss function value is used to measure authenticity of the predicted reconstruction image.

In one embodiment, the calculation module 1205 is further configured to calculate the first loss function value based on a second feature corresponding to the second sample image and a third feature corresponding to the single degradation image.

In one embodiment, the calculation module 1205 is further configured to calculate the second loss function value based on a first feature corresponding to the first sample image and a fourth feature corresponding to the predicted reconstruction image.

In one embodiment, the updating module 1206 is further configured to update a model parameter of the image reconstruction model based on a sum of the first loss function value and the second loss function value.

In one embodiment, the calculation module 1205 is further configured to calculate the first loss function value based on a second feature corresponding to an i^{th} second sample image of the at least two second sample images and a third feature corresponding to an i^{th} single degradation image of the at least two single degradation images, where i is a positive integer.

The loss function value further includes a third loss function value and a fourth loss function value, the third loss function value is used to measure a similarity between a non-content part in the multiple degradation image and a non-content part in the first sample image, and the fourth loss function value is used to measure a similarity between the first sample image and the predicted reconstruction image.

In one embodiment, the calculation module 1205 is further configured to calculate the third loss function value based on a structural feature corresponding to the multiple degradation image and a structural feature corresponding to the first sample image.

In one embodiment, the calculation module 1205 is further configured to calculate the fourth loss function value based on a content feature and a texture feature that correspond to the first sample image and a content feature and a texture feature that correspond to the predicted reconstruction image.

In one embodiment, the updating module 1206 is further configured to update the model parameter of the image reconstruction model based on a sum of the first loss function value, the second loss function value, the third loss function value, and the fourth loss function value.

The damage type includes at least one of a blur damage type, a noise damage type, and a bias damage type.

In one embodiment, the obtaining module 1201 is further configured to obtain a first image, where the first image is an image having a plurality of damage types.

In one embodiment, the reconstruction module 1204 is further configured to: perform image reconstruction processing on the first image based on a trained reconstruction network layer, to obtain a first reconstruction image, where the first reconstruction image is an image obtained by removing the plurality of damage types from the first image; and output the first reconstruction image.

The term module (and other similar terms such as submodule, unit, subunit, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

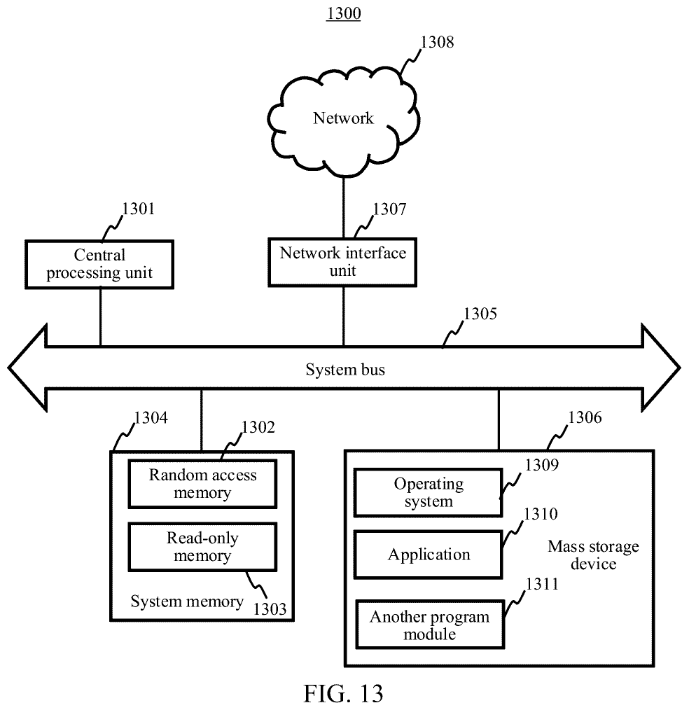

FIG. 13 is a block diagram of a structure of a computer device 1300 according to an exemplary embodiment of the present disclosure. The computer device may be implemented as the server in the foregoing solutions of the present disclosure. An image computer device 1300 includes a central processing unit (CPU) 1301, a system memory 1304 including a random access memory (RAM) 1302 and a read-only memory (ROM) 1303, and a system bus 1305 connecting the system memory 1304 and the central processing unit 1301. The image computer device 1300 further includes a mass storage device 1306 configured to store an operating system 1309, an application 1310, and another program module 1311.

The mass storage device 1306 is connected to the central processing unit 1301 through a mass storage controller (not shown) connected to the system bus 1305. The mass storage device 1306 and an associated computer-readable medium provide non-volatile storage for the image computer device 1300. To be specific, the mass storage device 1306 may include the computer-readable medium (not shown) such as a hard disk or a CD-ROM (CD-ROM) drive.

Without a loss of generality, the computer-readable medium may include a computer storage medium and a communication medium. The computer storage medium includes a volatile and non-volatile, removable, and non-removable medium implemented by using any method or technology for storing information such as computer-readable instructions, a data structure, a program module, or another data. The computer storage medium includes the RAM, the ROM, an erasable programmable read only memory (EPROM), an electronic-erasable read-only memory (EEPROM) flash memory, or another solid-state storage technology, the CD-ROM, a digital versatile disc (DVD), or another optical storage, a tape cartridge, a tape, disk storage, or another magnetic storage device. Certainly, a person skilled in the art may learn that the computer storage medium is not limited to the foregoing several types. The system memory 1304 and the mass storage device 1306 may be collectively referred to as the memory.

In accordance with various embodiments of this disclosure, the image computer device 1300 may also be connected to a remote computer on a network over a network, such as the internet, to run. To be specific, the image computer device 1300 may be connected to a network 1308 by using a network interface unit 1307 connected to the system bus 1305, or may be connected to another type of network or a remote computer system (not shown) by using the network interface unit 1307.

The memory further includes at least one computer program, the at least one computer program is stored in the memory, and the central processing unit 1301 executes the at least one program to implement all or some of operations of the training method of the image reconstruction model shown in the foregoing embodiments.

Embodiments of the present disclosure further provide a computer device. The computer device includes a processor and a memory. The memory stores at least one program, and the at least one program is loaded and executed by the processor to implement the training method of the image reconstruction model provided in the foregoing method embodiments.

Embodiments of the present disclosure further provide a computer-readable storage medium. The storage medium stores at least one computer program, and the at least one computer program is loaded and executed by a processor to implement the training method of the image reconstruction model provided in the foregoing method embodiments.

Embodiments of the present disclosure further provide a computer program product. The computer program product includes a computer program, and the computer program is stored in a computer-readable storage medium. The computer program is read and executed by a processor of a computer device from the computer-readable storage medium, to enable the computer device to execute the computer program to implement the training method of the image reconstruction model provided in the foregoing method embodiments.

In a specific implementation of the present disclosure, when foregoing embodiments of the present disclosure are applied to a specific product or technology, user permission or consent need to be obtained for related data such as data, historical data, and user data processing related to a user identity or a feature, such as a profile, collection, use, and processing of the related data need to comply with the laws, regulations, and standards of related countries and regions.

What is claimed is:

1. A training method of an image reconstruction model, wherein the method is executed by a terminal device, and the method comprises:
obtaining a first sample image and at least two types of second sample images, wherein a second sample image has a single damage type, and image quality of the first sample image is greater than image quality of the second sample image;
respectively adding at least two damage features corresponding to the second sample images to the first sample image, to generate at least two types of single degradation images;
fusing the at least two types of the single degradation images, to obtain a multiple degradation image corresponding to the first sample image, wherein the multiple degradation image has at least two damage types;
performing image reconstruction processing on the multiple degradation image, to generate a predicted reconstruction image corresponding to the multiple degradation image;
calculating a loss function value based on the second sample images, the single degradation images, the first sample image, and the predicted reconstruction image; and
updating a model parameter of the image reconstruction model based on the loss function value.

2. The method according to claim 1, wherein the respectively adding at least two damage features corresponding to the second sample images to the first sample image, to generate at least two types of single degradation images comprises:
obtaining a first feature corresponding to the first sample image, and respectively obtaining at least two second features corresponding to the at least two types of the second sample images, wherein the first feature represents an image feature of the first sample image, and the second feature represents an image feature of one of the second sample images; and
for one of the at least two second features, obtaining, based on the first feature and the one second feature, a damage feature corresponding to one of the second sample images; and adding the damage feature to the first feature of the first sample image, to obtain one of the single degradation images corresponding to the first sample image.

3. The method according to claim 2, wherein the image reconstruction model comprises a degradation network layer, and the degradation network layer comprises a first degradation encoder; and
the obtaining a first feature corresponding to the first sample image, and respectively obtaining at least two types of second features corresponding to the second sample images comprises:
extracting the first feature corresponding to the first sample image by using the first degradation encoder, and respectively extracting the at least two second features corresponding to the at least two types of the second sample images by using the first degradation encoder.

4. The method according to claim 2, wherein the image reconstruction model comprises a degradation network layer, and the degradation network layer comprises a damage kernel extractor; and
the obtaining, based on the first feature and the one second feature, the damage feature corresponding to one of the second sample images comprises:
determining the damage feature by comparing the first feature and the second feature, and performing decoupling by using the damage kernel extractor, to obtain, from the one second feature, the damage feature corresponding to the one of the second sample images.

5. The method according to claim 2, wherein the image reconstruction model comprises a degradation network layer, and the degradation network layer comprises a first degradation decoder; and
the adding the damage feature to the first feature of the first sample image, to obtain one of the single degradation images corresponding to the first sample image comprises:
adding the damage feature to the first feature of the first sample image, to obtain an intermediate first feature; and inputting the intermediate first feature to the first degradation decoder for decoding processing, to obtain the one of the single degradation images corresponding to the first sample image.

6. The method according to claim 1, wherein the fusing the at least two types of single degradation images, to obtain a multiple degradation image corresponding to the first sample image comprises:
obtaining at least two third features corresponding to the at least two types of the single degradation images, and fusing the at least two third features, to obtain the multiple degradation image corresponding to the first sample image, wherein the third feature represents an image feature of one of the single degradation images.

7. The method according to claim 6, wherein a degradation network layer of the image reconstruction model further comprises a second degradation encoder and a second degradation decoder; and
the obtaining at least two third features corresponding to the at least two types of the single degradation images, and fusing the at least two third features, to obtain the multiple degradation image corresponding to the first sample image comprises:
obtaining the at least two third features corresponding to the at least two types of the single degradation images by using the second degradation encoder, and fusing the at least two third features, to obtain a degradation fusion feature; and
performing decoding processing on the degradation fusion feature by using the second degradation decoder, to generate the multiple degradation image corresponding to the first sample image.

8. The method according to claim 1, wherein the image reconstruction model comprises a reconstruction network layer, and the reconstruction network layer comprises a reconstruction encoder and a reconstruction decoder; and
the performing image reconstruction processing on the multiple degradation image, to generate a predicted reconstruction image corresponding to the multiple degradation image comprises:
inputting the multiple degradation image to the reconstruction encoder for feature extraction, to obtain an image reconstruction feature; and
performing decoding processing on the image reconstruction feature by using the reconstruction decoder, to generate the predicted reconstruction image corresponding to the multiple degradation image.

9. The method according to claim 1, wherein the loss function value comprises first loss function values and a second loss function value, each first loss function value indicates a similarity between one of the second sample images and one of the single degradation images corresponding to the one second sample image, and the second loss function value indicates an authenticity of the predicted reconstruction image;
the calculating a loss function value based on the second sample images, the single degradation images, the first sample image, and the predicted reconstruction image comprises:
calculating the first loss function values based on second features corresponding to the second sample images and third features corresponding to the single degradation images; and
calculating the second loss function value based on a first feature corresponding to the first sample image and a fourth feature corresponding to the predicted reconstruction image, wherein the fourth feature represents an image feature of the predicted reconstruction image; and
the updating a model parameter of the image reconstruction model based on the loss function value comprises:
updating the model parameter of the image reconstruction model based on a sum of the first loss function values and the second loss function value.

10. The method according to claim 9, wherein the calculating the first loss function values based on second features corresponding to the second sample images and third features corresponding to the single degradation images comprises:
calculating one of the first loss function values based on a second feature corresponding to an i^{th} second sample image of the second sample images and a third feature corresponding to an i^{th} single degradation image of the single degradation images, wherein i is a positive integer.

11. The method according to claim 9, wherein the loss function value further comprises a third loss function value and a fourth loss function value, the third loss function value indicates a similarity between a non-content part in the multiple degradation image and a non-content part in the first sample image, and the fourth loss function value indicates a similarity between the first sample image and the predicted reconstruction image; and the method further comprises:
calculating the third loss function value based on a structural feature corresponding to the multiple degradation image and a structural feature corresponding to the first sample image; and
calculating the fourth loss function value based on a content feature and a texture feature that correspond to the first sample image and a content feature and a texture feature that correspond to the predicted reconstruction image; and
the updating a model parameter of the image reconstruction model based on a sum of the first loss function value and the second loss function value comprises:
updating the model parameter of the image reconstruction model based on a sum of the first loss function values, the second loss function value, the third loss function value, and the fourth loss function value.

12. The method according to claim 8, further comprising:
obtaining a first image, wherein the first image is an image having a plurality of damage types;
performing image reconstruction processing on the first image based on the reconstruction network layer, to obtain a first reconstruction image; and
outputting the first reconstruction image.

13. A training apparatus of an image reconstruction model, wherein the apparatus comprises: at least one processor and at least one memory, the at least one memory stores at least one computer program, and the at least one computer program is loaded and executed by the at least one processor to:
obtain a first sample image and at least two types of second sample images, wherein each second sample image has a single damage type, and image quality of the first sample image is greater than image quality of the second sample image;
respectively add at least two damage features corresponding to the second sample images to the first sample image, to generate at least two types of single degradation images;
fuse the at least two types of the single degradation images, to obtain a multiple degradation image corresponding to the first sample image, wherein the multiple degradation image has at least two damage types;
perform image reconstruction processing on the multiple degradation image, to generate a predicted reconstruction image corresponding to the multiple degradation image;
calculate a loss function value based on the second sample images, the single degradation images, the first sample image, and the predicted reconstruction image; and
update a model parameter of the image reconstruction model based on the loss function value.

14. The apparatus according to claim 13, wherein the at least one processor is further configured to:
obtain a first feature corresponding to the first sample image, and respectively obtain at least two second features corresponding to the at least two types of the second sample images, wherein the first feature represents an image feature of the first sample image, and the second feature represents an image feature of one of the second sample images; and
for one of the at least two second features, obtain, based on the first feature and the one second feature, a damage feature corresponding to one of the second sample images; and add the damage feature to the first feature of the first sample image, to obtain one of the single degradation images corresponding to the first sample image.

15. The apparatus according to claim 14, wherein the image reconstruction model comprises a degradation network layer, and the degradation network layer comprises a first degradation encoder; and
the at least one processor is further configured to: extract the first feature corresponding to the first sample image by using the first degradation encoder, and respectively extract the at least two second features corresponding to the at least two types of the second sample images by using the first degradation encoder.

16. The apparatus according to claim 14, wherein the image reconstruction model comprises a degradation network layer, and the degradation network layer comprises a damage kernel extractor; and
the at least one processor is further configured to: determine the damage feature by comparing the first feature and the second feature, and perform decoupling by using the damage kernel extractor, to obtain, from the one second feature, the damage feature corresponding to the one of the second sample images.

17. The apparatus according to claim 14, wherein image reconstruction model comprises a degradation network layer, and the degradation network layer comprises a first degradation decoder; and
the at least one processor is further configured to: add the damage feature to the first feature of the first sample image, to obtain an intermediate first feature; and input the intermediate first feature to the first degradation decoder for decoding processing, to obtain one of the single degradation images corresponding to the first sample image.

18. The apparatus according to claim 14, wherein the at least one processor is further configured to:
obtain at least two third features corresponding to the at least two types of the single degradation images, and
fuse the at least two third features, to obtain the multiple degradation image corresponding to the first sample image, wherein the third feature represents an image feature of one of the single degradation images.

19. The apparatus according to claim 15, wherein a degradation network layer of the image reconstruction model further comprises a second degradation encoder and a second degradation decoder; and the at least one processor is further configured to:
obtain the at least two third features corresponding to the at least two types of the single degradation images by using the second degradation encoder, and fusing the at least two third features, to obtain a degradation fusion feature; and
perform decoding processing on the degradation fusion feature by using the second degradation decoder, to generate the multiple degradation image corresponding to the first sample image.

20. A non-transitory computer-readable storage medium, wherein the computer-readable storage medium stores at least one computer program, and the at least one computer program is loaded and executed by a processor to implement:
obtaining a first sample image and at least two types of second sample images, wherein a second sample image has a single damage type, and image quality of the first sample image is greater than image quality of the second sample image;
respectively adding at least two damage features corresponding to the second sample images to the first sample image, to generate at least two types of single degradation images;
fusing the at least two types of the single degradation images, to obtain a multiple degradation image corresponding to the first sample image, wherein the multiple degradation image has at least two damage types;
performing image reconstruction processing on the multiple degradation image, to generate a predicted reconstruction image corresponding to the multiple degradation image;
calculating a loss function value based on the second sample images, the single degradation images, the first sample image, and the predicted reconstruction image; and
updating a model parameter of the image reconstruction model based on the loss function value.
